(19) United States
(12) Patent Application Publication
(10) Pub. No.: US 2014/0360217 A1
(43) Pub. Date: Dec. 11, 2014

(54) COOLING SYSTEM FOR USE IN A TURBINE ASSEMBLY AND METHOD OF ASSEMBLY

(71) Applicant: BHA Altair, LLC, Franklin, TN (US)

(72) Inventor: Timothy John Nicholas, Southampton (GB)

(73) Assignee: BHA Altair, LLC, Franklin, TN (US)

(21) Appl. No.: 13/915,291

(22) Filed: Jun. 11, 2013

(51) Int. Cl. F02C 7/18

(52) U.S. Cl. CPC F02C 7/185; F05D 2230/60
USPC 62/314; 29/888

(57) ABSTRACT

A cooling system for use in a turbine assembly is provided. The cooling system includes a first filter configured to remove particles entrained in a flow of intake air, an array of nozzles downstream from the first filter, and a second filter downstream from the array. The array of nozzles is configured to facilitate reducing a temperature of the intake air, and the second filter is configured to repel cooling liquid discharged from the array of nozzles while allowing cooled intake air to flow therethrough.

### BACKGROUND OF THE INVENTION

The field of the present disclosure relates generally to turbines and, more specifically, to systems and methods for use in reducing the temperature of compressor intake air.

Rotary machines, such as gas turbines, are often used to generate power for electric generators. Gas turbines, for example, have a working fluid path which typically includes, in serial-flow relationship, an air intake, a compressor, a combustor, a turbine, and a gas outlet. Compressor and turbine sections include at least one row of circumferentially-spaced rotating buckets or blades positioned within a housing. At least some known turbine engines are used in cogeneration facilities and power plants.

Generally, gas turbines use intake air during normal operation for combustion purposes. Intake air is drawn through a filter house towards the compressor. The compressor-discharge air is mixed with fuel and ignited in the combustor. Because gas turbines are constant volume, air-breathing engines, many factors and characteristics of intake air, such as the temperature, pressure, and/or humidity of the intake air, may affect the power output and overall efficiency of a gas turbine system. For example, when the temperature of intake air is low, its density increases resulting in a higher mass flow rate flowing through the gas turbine. During such operating conditions, the power output and overall efficiency of the turbine engine is increased.

At least some known turbine assemblies use an evaporative cooler and/or a fogger nozzle array to reduce the temperature of air being channeled towards the compressor. Evaporative coolers and fogger nozzle arrays reduce the temperature of air either through the evaporation or atomization of water. However, the effectiveness of evaporative cooling is a function of the humidity of the ambient air and its effectiveness may be reduced in climates having a high relative humidity. Further, known fogger nozzle arrays generally may not be used in combination with water removal systems because atomized water may damage downstream turbine components.

### BRIEF DESCRIPTION OF THE INVENTION

In one aspect, a cooling system for use in a turbine assembly is provided. The cooling system includes a first filter configured to remove particles entrained in a flow of intake air, an array of nozzles downstream from the first filter, and a second filter downstream from the array. The array of nozzles is configured to facilitate reducing a temperature of the intake air, and the second filter is configured to repel cooling liquid discharged from the array of nozzles while allowing cooled intake air to flow therethrough.

In another aspect, a gas turbine assembly is provided. The assembly includes a filter house and a duct coupled to an outlet of the filter house. The filter house includes a first filter configured to remove particles entrained in a flow of intake air, an array of nozzles downstream from the first filter, and a second filter downstream from the array. The array of nozzles is configured to facilitate reducing a temperature of the intake air, and the second filter is configured to repel cooling liquid discharged from the array of nozzles while allowing cooled intake air to flow therethrough. The duct is configured to channel the cooled intake air downstream therefrom.

In yet another aspect, a method of assembling a cooling system for use in a turbine assembly is provided. The method includes coupling a first filter within a filter house, positioning an array of nozzles downstream from the first, and positioning a second filter downstream from the array. The first filter is configured to remove particles entrained in a flow of intake air, the array is configured to facilitate reducing a temperature of the intake air, and the second filter is configured to repel cooling liquid discharged from the array of nozzles while allowing cooled intake air to flow therethrough.

### BRIEF DESCRIPTION OF THE DRAWINGS

FIG. 1 is a schematic illustration of an exemplary gas turbine power system.

FIG. 2 is a schematic illustration of an exemplary filtration system that may be used with the power system shown in FIG. 1.

### DETAILED DESCRIPTION OF THE INVENTION

Embodiments of the present disclosure relate to systems and methods for use in reducing the temperature of compressor intake air. More specifically, the systems described herein include an array of fogger nozzles and a filter assembly that includes a filter media fabricated from hydrophobic material. The nozzle array and the filter assembly are each downstream from a high-efficiency filter array within a filter house. In the exemplary embodiment, the nozzle array discharges cooling liquid towards the hydrophobic filter assembly to facilitate reducing a temperature of the intake air, and the hydrophobic filter assembly repels the cooling liquid while allowing the cooled intake air to flow therethrough. The nozzle array and the hydrophobic filter assembly may be installed in new turbine assemblies and/or retrofitted in existing turbine assemblies to replace known evaporative coolers. As such, the systems described herein facilitate reducing compressor intake air temperature using a smaller, less complicated, and more cost-effective filter house assembly.

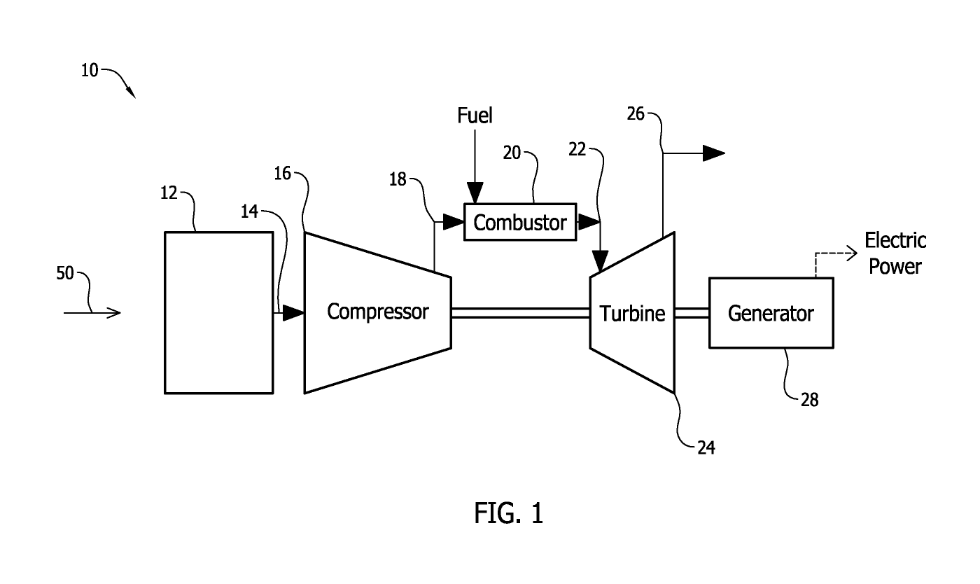

FIG. 1 is a schematic diagram of an exemplary gas turbine power system 10. In the exemplary embodiment, gas turbine power system 10 includes, in serial-flow relationship, a filtration system 12, an axial flow compressor 16, a combustor 20, and a gas turbine 24. Intake air 50 is filtered in filtration system 12 and filtered intake air 14 is directed to axial flow compressor 16. Intake air 50 is at ambient air temperature. Compressed air 18 is directed to combustor 20 where fuel is injected with compressed air 18 for combustion purposes. Hot gas 22 is discharged from combustor 20 and is directed to gas turbine 24 where the thermal energy of hot gas 22 is converted to work. A portion of the work is used to drive compressor 16, and the balance is used to drive an electric generator 28 to generate electric power. A hot exhaust gas mixture 26 is discharged from gas turbine 24 and channeled to either the atmosphere or to a Heat Recovery Steam Generator (HRSG) (not shown).

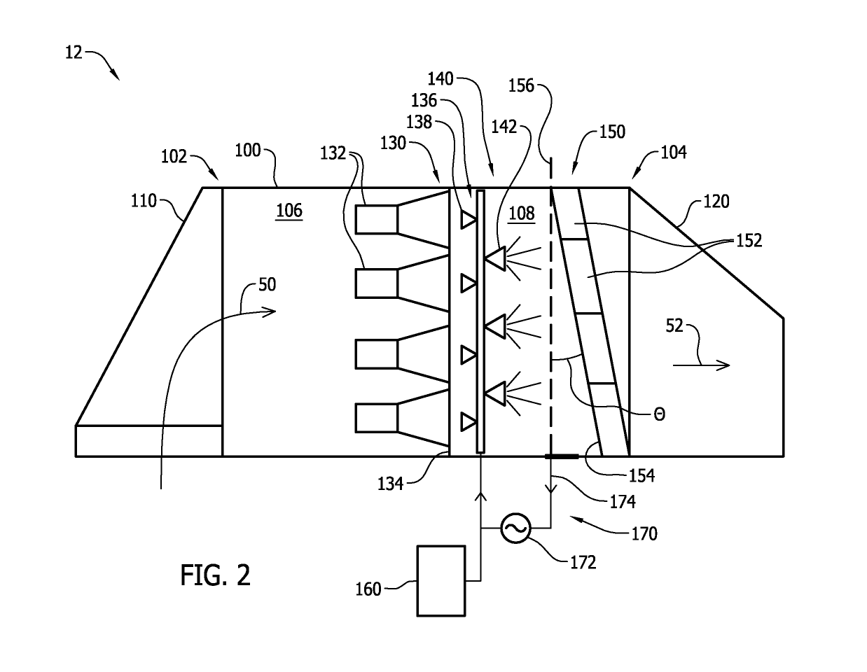

FIG. 2 is a schematic illustration of an exemplary filtration system 12. In the exemplary embodiment, filtration system 12 includes a filter house 100, a weather hood 110 coupled to an inlet 102 of filter house 100, and a transition duct 120 coupled to an outlet 104 of filter house 100. Weather hood 110 facilitates blocking inclement weather such as rain, snow, and large airborne particles from entering filtration system 12. In one embodiment, weather hood 110 may include a plurality of coalescent pads (not shown) to prevent the ingestion of water droplets and/or snowflakes into filtration system 12. Further, in operation, transition duct 120 channels intake air 50 downstream from filter house 100 towards compressor 16 (shown in FIG. 1).

In the exemplary embodiment, filter house 100 includes a first filter assembly 130, a nozzle array 140 downstream from first filter assembly 130, and a second filter assembly 150 downstream from nozzle array 140. In the exemplary embodiment, first filter assembly 130 removes airborne particles from intake air 50, and includes a plurality of filter elements 132 coupled to a tube sheet 134. Tube sheet 134 extends through filter house 100 to define a first plenum 106 and a second plenum 108 within filter house 100. As such, first plenum 106 generally removes airborne particles from the ambient environment and second plenum 108 remains substantially free of airborne particles. Further, in the exemplary embodiment, first filter assembly 130 includes a pulse cleaning system 136 that periodically directs a flow of cleaning air towards filter elements 132 to remove collected particulates therefrom. More specifically, pulse cleaning system 136 includes a plurality of cleaning nozzles 138 that direct the cleaning air towards filter elements 132 to facilitate reducing a pressure drop across filter elements 132 caused by a build-up of airborne particles thereon.

In some embodiments, filter elements 132 are high-efficiency filters. As used herein, the term “high-efficiency filter” means a filter that may be measured in accordance with at least one of EN1822 (2009) and EN779 (2011). As such, filter elements 132 facilitate reducing an amount of airborne particles contained within intake air 50 and channeled towards second filter assembly 150 to facilitate reducing a mixture of particles and cooling fluid, or cake, from blocking the flow of intake air 50 therethrough.

In the exemplary embodiment, nozzle array 140 includes a plurality of fogger nozzles 142 that spray a cooling liquid 144 towards second filter assembly 150 to facilitate reducing a temperature of intake air 50. In some embodiments, cooling liquid 144 either saturates intake air 50 and/or cooling liquid 144 forms a layer (not shown) of cooling liquid on a surface 154 of second filter assembly 150. Cooling liquid 144 may be any liquid that enables filtration system 12 to function as described herein. An exemplary cooling liquid includes, but is not limited to, water. Further, cooling liquid 144 may be supplied at any temperature that facilitates increasing a power output of gas turbine power system 10 (shown in FIG. 1). For example, the temperature of cooling liquid 144 may be selected based on an ambient temperature of intake air 50. In some embodiments, cooling liquid 144 is used to facilitate reducing a temperature of intake air 50 down to a temperature of about 45° F. (7° C.).

In the exemplary embodiment, cooling liquid 144 is supplied to nozzle array 140 from either a chilled water source 160 and/or a water recirculation system 170. Water recirculation system 170 includes a heat exchanger 172 and a conduit 174 coupled between filter house 100 and heat exchanger 172. In the exemplary embodiment, conduit 174 channels cooling liquid run-off from second filter assembly 150, and heat exchanger 172 facilitates cooling the spent cooling liquid for further use with nozzle array 140.

In the exemplary embodiment, second filter assembly 150 repels cooling liquid 144 while allowing intake air 50 to flow therethrough. More specifically, second filter assembly 150 may be formed from a predetermined array of filter elements 152. In one embodiment, the array may be arranged such that filter elements 152 are substantially co-planar relative to the flow of intake air 50. In the exemplary embodiment, filter elements 152 include a filter media (not shown) fabricated from a hydrophobic material. Exemplary hydrophobic materials include, but are not limited to, an expanded-polytetrafluoroethylene (ePTFE) material, C6 and C8 fluorocarbon materials, and plasma treated materials. Further, filter elements 152 may have any configuration that enables filtration system 12 to function as described herein. For example, filter elements 152 may have a V-panel configuration or a Z-panel configuration to facilitate increasing a surface area of second filter assembly 150.

In some embodiments, filter elements 152 are high-efficiency filters. As such, intake air 50 channeled through outlet 104 and into transition duct 120 is cooled to a desired temperature and is substantially free of airborne particles and cooling liquid.

In some embodiments, second filter assembly 150 is oriented obliquely relative to a vertical axis 156. More specifically, second filter assembly 150 is angled towards nozzle array 140 to enable cooling liquid to be drained from filter assembly 150. In the exemplary embodiment, second filter assembly 150 may have an angle θ defined within a range between about 0 degrees and about 20 degrees relative to vertical axis 156. As such, draining cooling liquid from filter assembly 150 facilitates reducing a pressure drop across filter assembly 150. In an alternative embodiment, second filter assembly 150 may be angled away from nozzle array 140 to facilitate increasing a residence time for cooling liquid 144 to be retained on surface 154. As such, contact between intake air 50 and cooling liquid 144 is increased to facilitate increasing a cooling efficiency of filtration system 12. Further, in an alternative embodiment, second filter assembly 150 may be oriented at any angle that enables filtration system 12 to function as described herein.

In operation, intake air 50 is channeled through weather hood 110 and into filter house 100. Intake air 50 is then channeled towards first filter assembly 130 to remove airborne particles therefrom. In some embodiments, the airborne particles are collected by first filter assembly 130 causing an increasing pressure drop across tube sheet 134. Accordingly, pulse cleaning system 136 periodically directs cleaning air towards filter elements 132 to facilitate maintaining operation of gas turbine power system 10.

After the airborne particles have been collected by first filter assembly 130, intake air 50 is directed past nozzle array 140 to facilitate reducing the temperature of intake air 50. More specifically, nozzle array 140 sprays cooling liquid 144 towards second filter assembly 150 and cooling liquid 144 saturates intake air 50 and/or is collected on surface 154 of second filter assembly 150. The cooled intake air 50 is then channeled towards second filter assembly 150 to remove cooling liquid 144 therefrom. In the exemplary embodiment, second filter assembly 150 is fabricated from a hydrophobic material that repels cooling liquid 144 and allows intake air 50 to flow therethrough. As such, a flow of cool, dry intake air 52 is discharged from filter house 100 and channeled towards compressor 16 via transition duct 120. In an alternative embodiment, second filter assembly 150 has a higher filtration efficiency than first filter assembly 130.

The systems and methods described herein facilitate increasing the power output of a turbine assembly by controlling a temperature of compressor intake air. More specifically, the systems described herein include a fogger nozzle array and a filter assembly fabricated from hydrophobic material positioned downstream from the fogger nozzle array. The fogger nozzle array sprays cooling liquid into the flow of intake air and the hydrophobic filter assembly removes the cooling liquid to facilitate reducing damage to downstream turbine components. As such, the cooling liquid facilitates reducing a temperature of the intake air such that the turbine assembly produces an improved power output. Further, the cooling systems described herein may be used in place of known evaporative coolers within existing and/or new filter houses. As such, the cooling system described herein is smaller, less complicated, and a cost-effective alternative in comparison to known evaporative cooling systems.

This written description uses examples to disclose the embodiments of the present disclosure, including the best mode, and also to enable any person skilled in the art to practice the embodiments, including making and using any devices or systems and performing any incorporated methods. The patentable scope of the embodiments are defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A cooling system for use in a turbine assembly, said system comprising:
a first filter configured to remove particles entrained in a flow of intake air;
an array of nozzles downstream from said first filter, said array of nozzles configured to facilitate reducing a temperature of the intake air; and
a second filter downstream from said array, said second filter configured to repel cooling liquid discharged from said array of nozzles while allowing cooled intake air to flow therethrough.

2. The system in accordance with claim 1, wherein the cooling system facilitates reducing the temperature of the intake air without the use of an evaporative cooler.

3. The system in accordance with claim 1, wherein said second filter comprises a filter media fabricated from a hydrophobic material.

4. The system in accordance with claim 3, wherein the hydrophobic material comprises at least one of an expanded-polytetrafluoroethylene (ePTFE) material, a C6 fluorocarbon material, a C8 fluorocarbon material, and plasma treated materials.

5. The system in accordance with claim 1, wherein said second filter comprises an array of filter elements.

6. The system in accordance with claim 5, wherein said filter array is obliquely oriented relative to a vertical axis at an angle between about 0 degrees and about 20 degrees from the vertical axis.

7. The system in accordance with claim 1, wherein said second filter comprises a high-efficiency filter that may be measured in accordance with at least one of EN1822 and EN779.

8. The system in accordance with claim 1, wherein said nozzle array is configured to discharge the cooling liquid towards said second filter to form a layer of cooling liquid on a surface of said second filter.

9. A gas turbine assembly comprising:
a filter house comprising:
a first filter configured to remove particles entrained in a flow of intake air;
an array of nozzles downstream from said first filter, wherein said array is configured to facilitate reducing a temperature of the intake air; and
a second filter downstream from said array, wherein said second filter is configured to repel cooling liquid discharged from said array of nozzles while allowing cooled intake air to flow therethrough; and
a duct coupled to an outlet of said filter house, wherein said duct is configured to channel the cooled intake air downstream therefrom.

10. The assembly in accordance with claim 9, wherein the intake air channeled through said filter house is facilitated to be cooled without the use of an evaporative cooler.

11. The assembly in accordance with claim 9, wherein said second filter comprises an array of filter elements.

12. The assembly in accordance with claim 9, wherein said filter array is obliquely oriented relative to a vertical axis at an angle between about 0 degrees and about 20 degrees from the vertical axis.

13. The assembly in accordance with claim 9, wherein said nozzle array is configured to discharge the cooling liquid towards said second filter to form a layer of cooling liquid on a surface of said second filter.

14. The assembly in accordance with claim 13, wherein the intake air is channeled through the layer of cooling liquid towards said second filter to facilitate reducing the temperature of the intake air.

15. The assembly in accordance with claim 9 further comprising a cooling liquid recirculation system that is configured to channel cooling liquid run-off from said second filter to said nozzle array.

16. A method of assembling a cooling system for use in a turbine assembly, said method comprising:
coupling a first filter within a filter house, wherein the first filter is configured to remove particles entrained in a flow of intake air;
positioning an array of nozzles downstream from the first filter, wherein the array is configured to facilitate reducing a temperature of the intake air; and
positioning a second filter downstream from the array, wherein the second filter is configured to repel cooling liquid discharged from the array of nozzles while allowing cooled intake air to flow therethrough.

17. The method in accordance with claim 16, wherein positioning an array of nozzles comprises orienting the array to spray the cooling liquid towards the second filter to form a layer of cooling liquid on a surface of the second filter.

18. The method in accordance with claim 16 further comprising orienting the second filter obliquely with respect to a vertical axis at an angle between about 0 degrees and about 20 degrees from the vertical axis.

19. The method in accordance with claim 16, wherein positioning a second filter comprises arranging an array of filter elements downstream from the nozzle array.

20. The method in accordance with claim 16 further comprising forming the second filter from a filter media fabricated from a hydrophobic material.
